(19) United States
(12) Patent Application Publication
(10) Pub. No.: US 2007/0177157 A1
(43) Pub. Date: Aug. 2, 2007

(54) Optical readhead

(75) Inventors: David Roberts McMurtry, Dursley (GB); James Reynolds Henshaw, Stround (GB); Michael Homer, London (GB); Mark Adrian Vincent Chapman, Wotton-under-Edge (GB); Raymond John Chaney, Berkeley (GB); William Ernest Lee, Bristol (GB); Jason Kempton Slack, Bristol (GB)

Correspondence Address: OLIFF & BERRIDGE, PLC, P.O. BOX 19928, ALEXANDRIA, VA, 22320, US

(73) Assignee: RENISHAW PLC, Wotton-under-edge (GB)

(21) Appl. No.: 10/590,443

(22) PCT Filed: Mar. 4, 2005
(86) PCT No.: PCT/GB05/00814

§ 371 Date: Aug. 24, 2006

(30) Foreign Application Priority Data
Mar. 4, 2004 (GB) 0404829.4

(51) Int. Cl. G01B 9/02

(52) U.S. Cl. 356/521

(57) ABSTRACT

Interferometry apparatus which comprises a measurement light beam (2a, 2b) and a reference light beam (2c, 2d) which interact with each other to cause a spatial fringe pattern (24). An optical device (12) is provided which interacts with the spatial fringe pattern (24), such that light is spatially separated into different directions (30, 32, 34, 36). The intensity modulation in two or more directions of the spatially separated light is phase shifted. The optical device may comprise, for example, a diffractive device, a refractive device or a diffractive optical element.

The present invention relates to a detection unit for an interferometer.

In an interferometry apparatus, two coherent beams are interfered together to form a spatial fringe field in the form of interference fringes at a detection unit, which contains electronics, such as photodiodes and amplifiers etc.

It would be advantageous to have a detection unit in which no electronics are required. This would allow the size of the detection unit to be reduced. Furthermore, if the detection unit does not have electronics the problem of electronic noise from other components (such as motors) is eliminated.

The electronics in the detection unit are a heat source which can cause measurement error due to expansion of parts of the apparatus such as the detection unit itself and the system which the interferometer is measuring. Thus it is desirable to remove this heat source.

The present invention provides interferometry apparatus comprising:

a measurement light beam and a reference light beam which interact with each other to cause a spatial fringe pattern;

an optical device which interacts with the spatial fringe pattern, such that light is spatially separated into different directions;

and wherein the intensity modulation in two or more directions of the spatially separated light is phase shifted.

The optical device may interact with the spatial fringe pattern such that within a fringe of the spatial fringe pattern, light is spatially separated into different directions.

The light may be spatially separated over at least a portion of one or more fringes of the spatial fringe pattern.

The light may be spatially separated into two or more sub-beams.

The spatially separated light in different directions may be detected by optical detectors. The spatially separated light may reach the detectors via optical fibres.

At least one focussing means may be provided to focus the spatially separated light in the different directions into the optical fibres or onto the optical detectors.

The optical device may comprise at least one fresnel lens.

The optical device may be a diffractive device.

In one embodiment, the optical device comprises a plurality of segments, wherein light from the spatial fringe field incident on each segment is diffracted into a different diffraction direction, thereby spatially separating the spatial fringe field.

The optical device may have a plurality of segments having different structures, the different segments being arranged in a repeating pattern. Two or more segments of the plurality of the segments may comprise blaze gratings, wherein the blaze gratings extend in different directions. One of the plurality of segments may have no structure.

The optical device may comprise a diffractive optical element.

The optical device may be a refractive device.

In one embodiment, the optical device may comprise a plurality of segments, wherein light from the spatial fringe field incident on each segment is refracted into a different direction, thereby spatially separating the spatial fringe field.

The optical device may have a profiled surface, such that refraction at the profiled surface causes spatial separation of the spatial fringe field.

The optical device may be configured such that the phase difference of the spatially separated light beam enables outputs of the detectors to be combined to generate two signals with a known phase difference. The optical device may be configured such that the phase difference of the spatially separated light beam enables outputs of the detectors to be combined to generate quadrature signals.

Embodiments of the invention will now be described by way of example and with reference to the accompanying drawings in which:

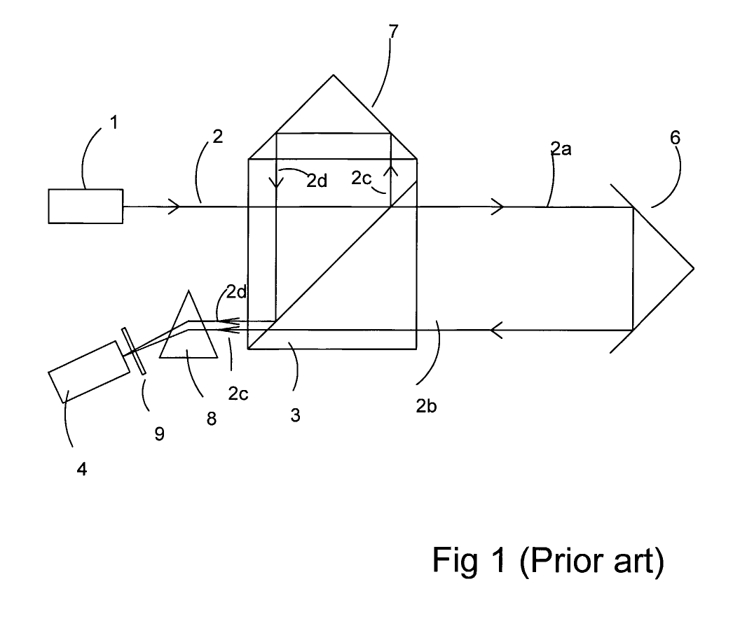

FIG. 1 illustrates a prior art interferometry apparatus;

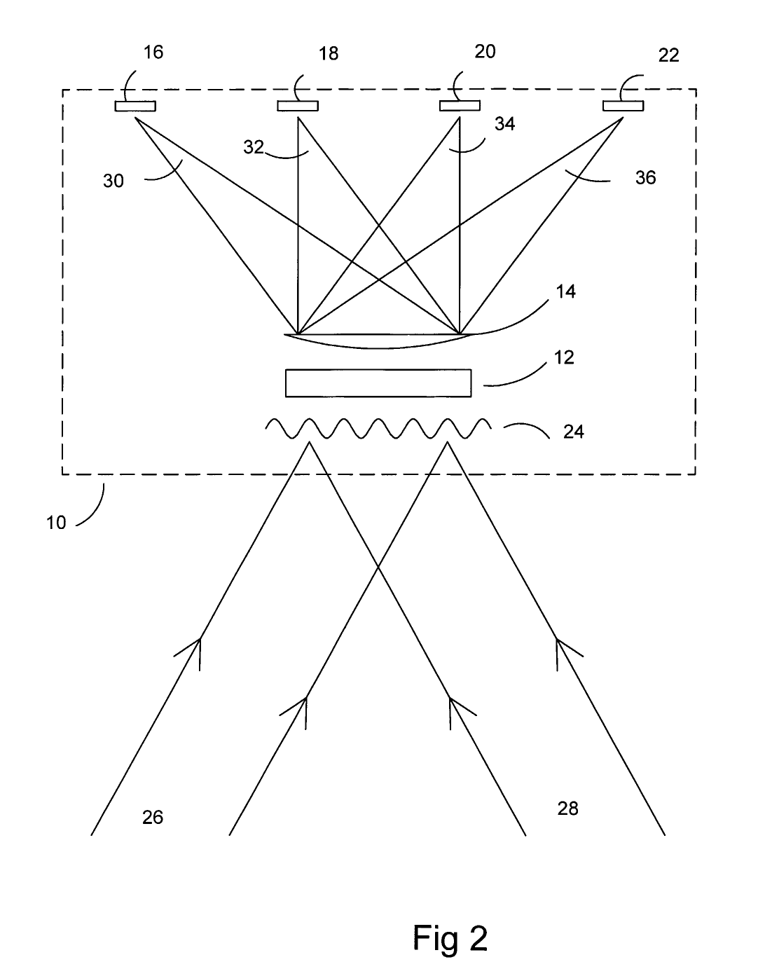

FIG. 2 is a representation of the detection unit of the present invention;

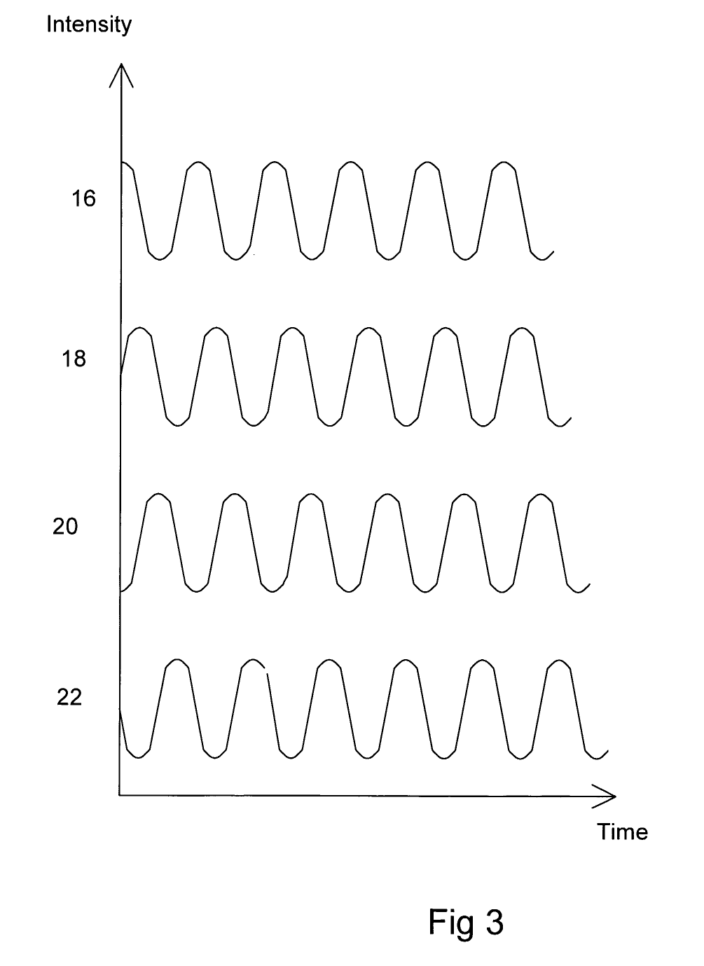

FIG. 3 illustrates the phase difference of the four resultant beams produced in the apparatus shown in FIG. 1;

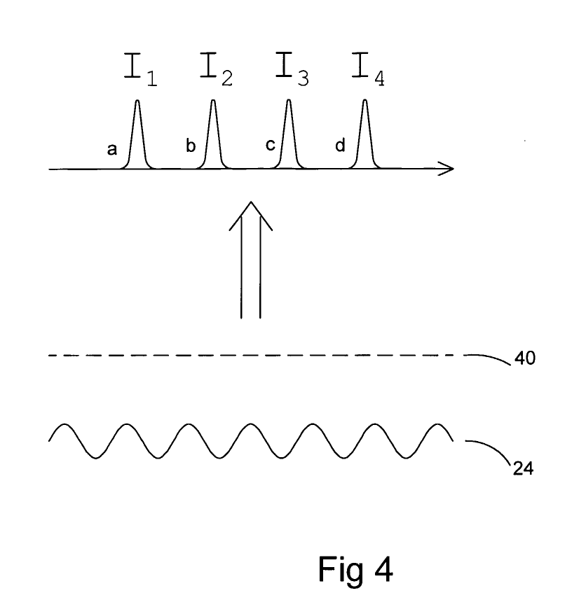

FIG. 4 illustrates the cosine fringes on a DOE to provide four beams;

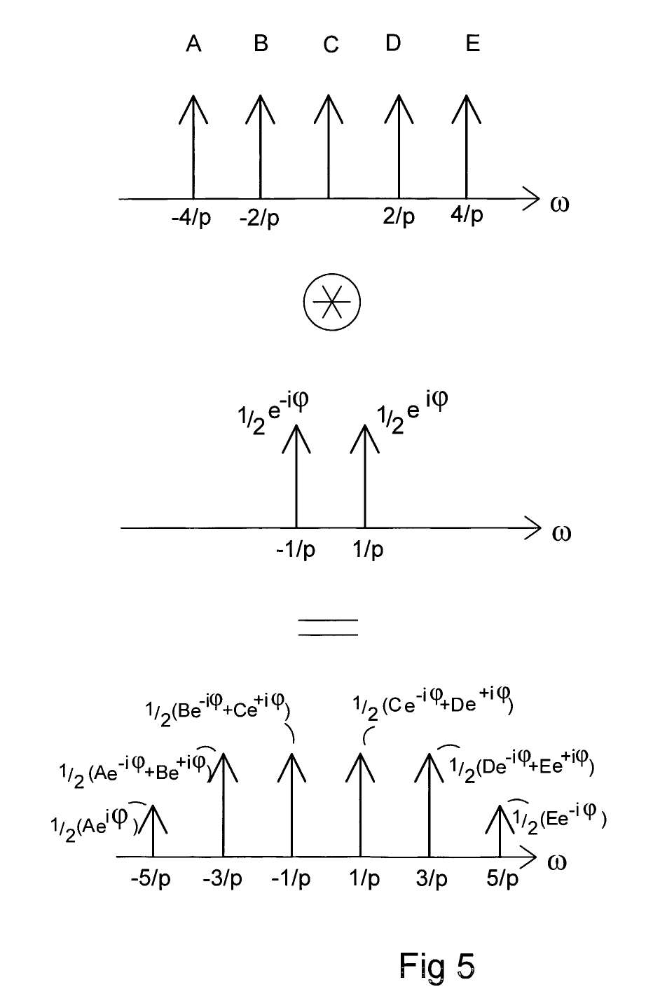

FIG. 5 illustrates the convolution of the complex amplitude of the grating Ωgrating(ω) and complex amplitude of the fringes Ωfringes(ω) to produce the output complex amplitude Ωout(ω);

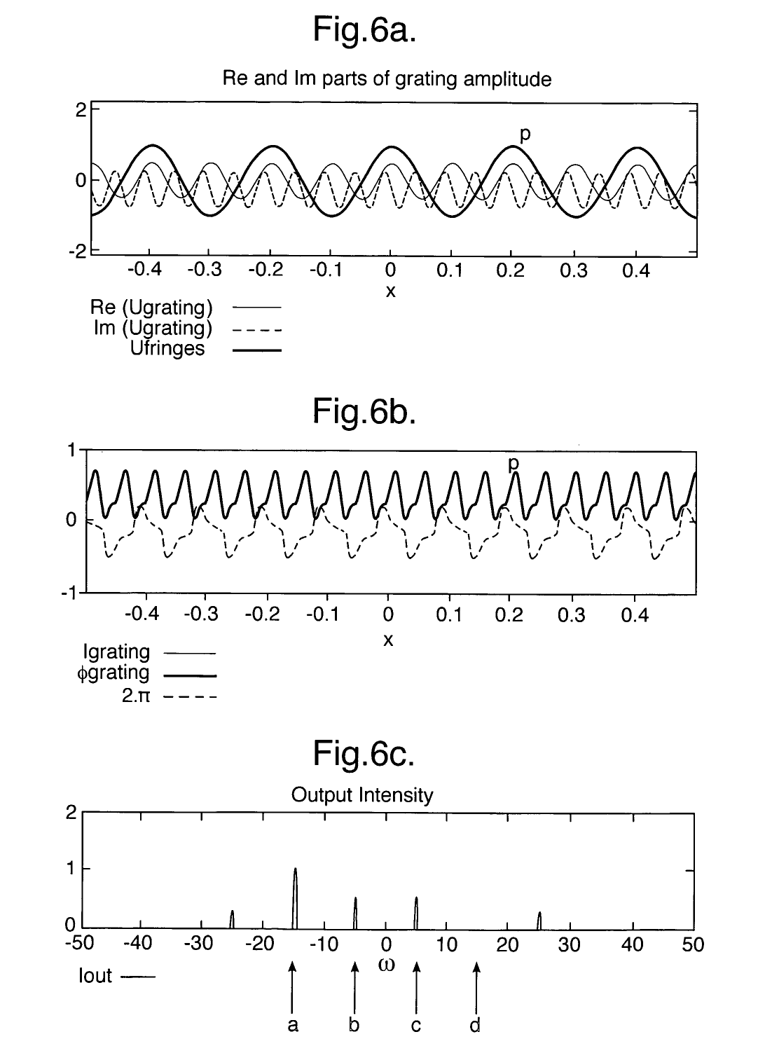

FIG. 6a illustrates the real and imaginary parts of the grating amplitude for a first solution;

FIG. 6b illustrates the phase and intensity of the grating for the first solution;

FIG. 6c illustrates the output intensity against angular displacement of the four resulting beams for the first solution;

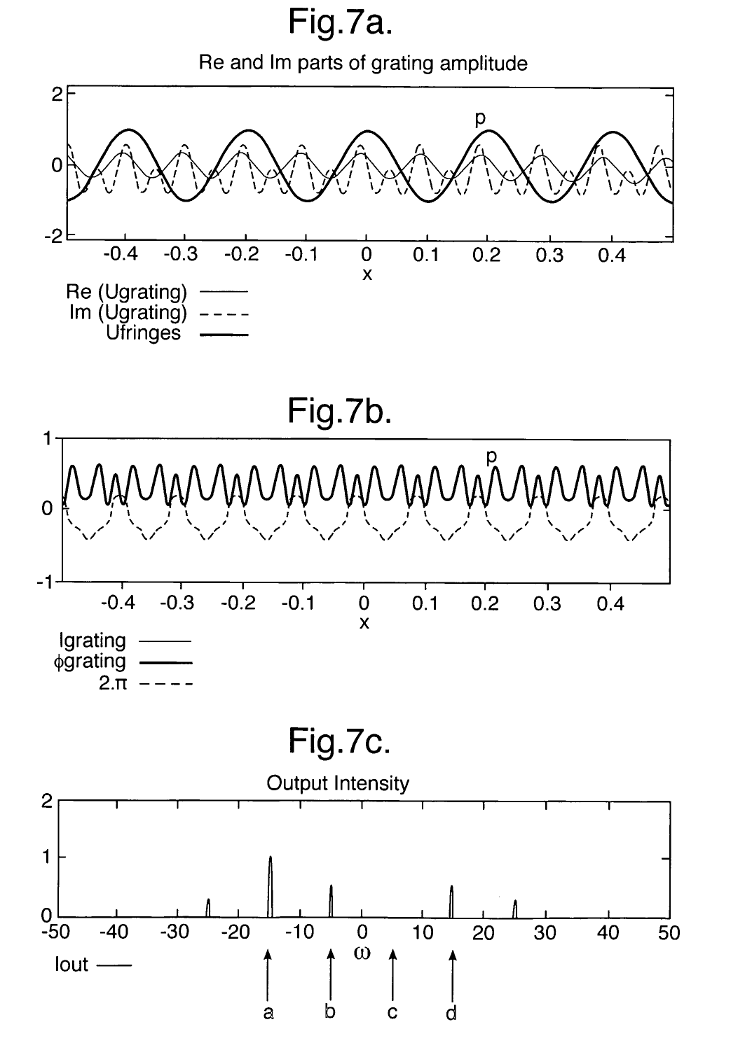

FIG. 7a illustrates the real and imaginary parts of the grating amplitude for a second solution;

FIG. 7b illustrates the phase and intensity of the grating for the second solution;

FIG. 7c illustrates the output intensity against angular displacement of the four resulting beams for the second solution;

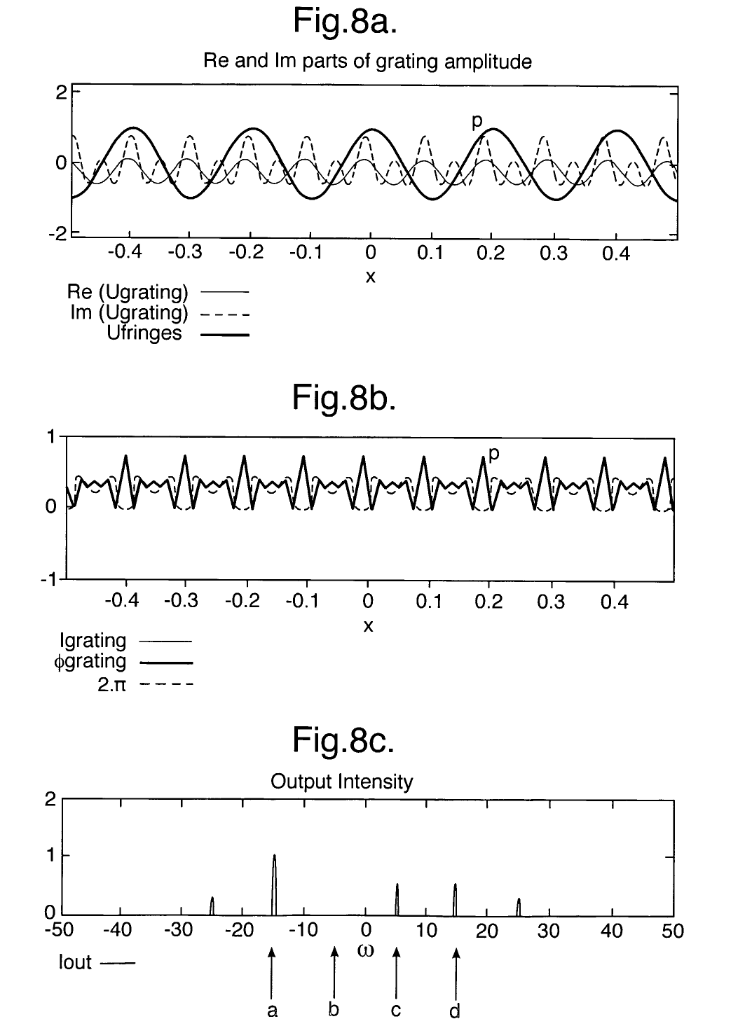

FIG. 8a illustrates the real and imaginary parts of the grating amplitude for a third solution;

FIG. 8b illustrates the phase and intensity of the grating for the third solution;

FIG. 8c illustrates the output intensity against angular displacement of the four resulting beams for the third solution;

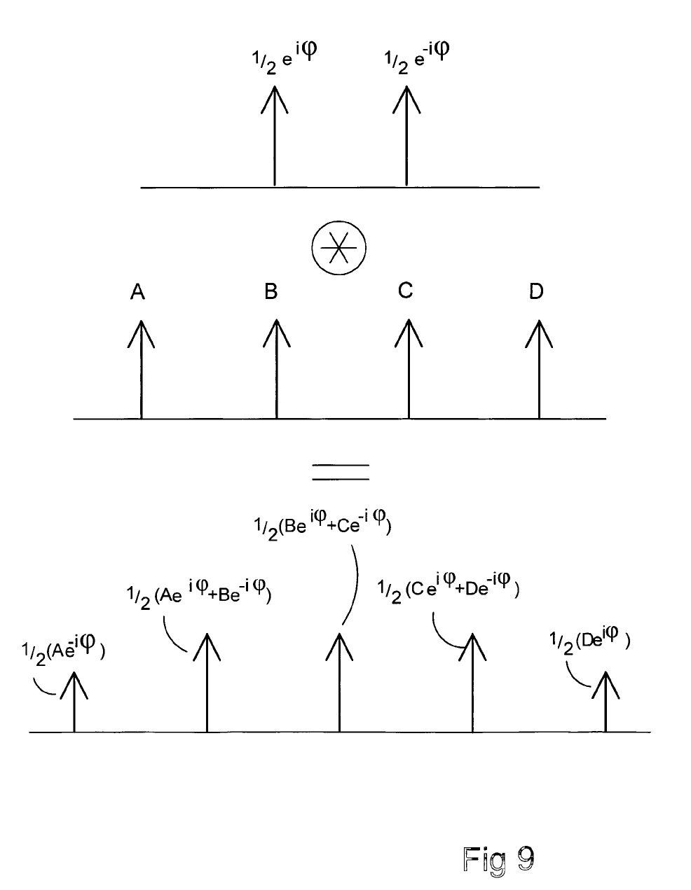

FIG. 9 illustrates the convolution of the complex amplitude of the grating Ωgrating(ω) and the complex amplitude of the fringes Ωfringes(ω) to produce an output complex amplitude Ωout(ω) for a three phase grating;

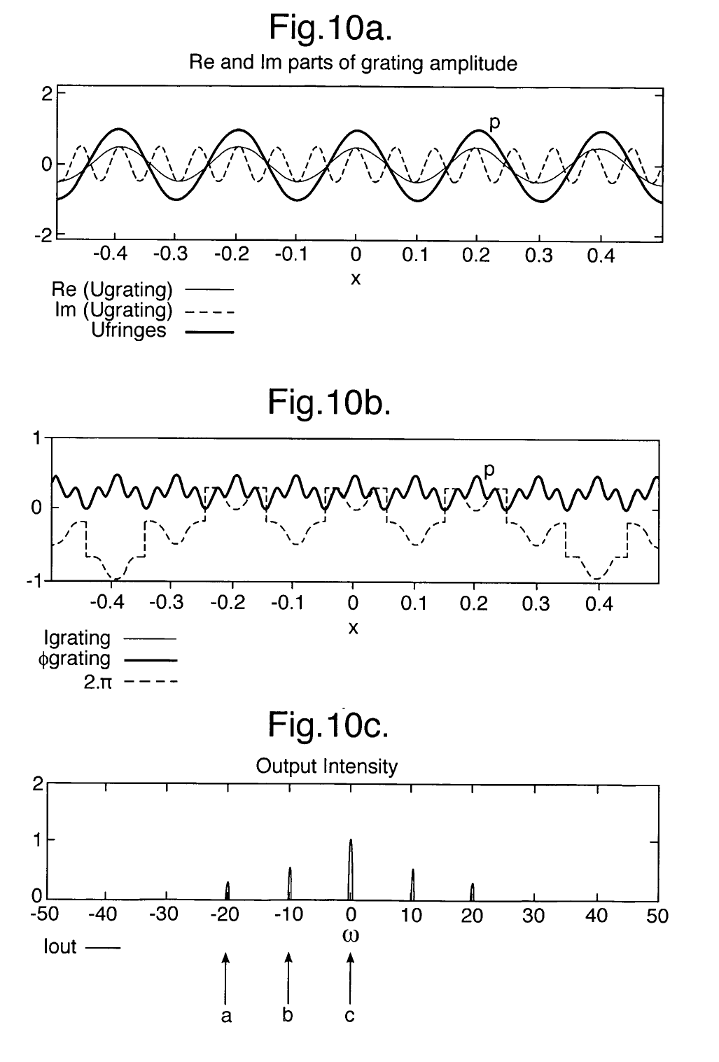

FIG. 10a illustrates the real and imaginary parts of the grating amplitude for a 3-phase splitting grating;

FIG. 10b illustrates the phase and intensity of the grating for a 3-phase splitting grating;

FIG. 10c illustrates the output intensity against angular displacement of the four resulting beams for a 3-phase splitting grating;

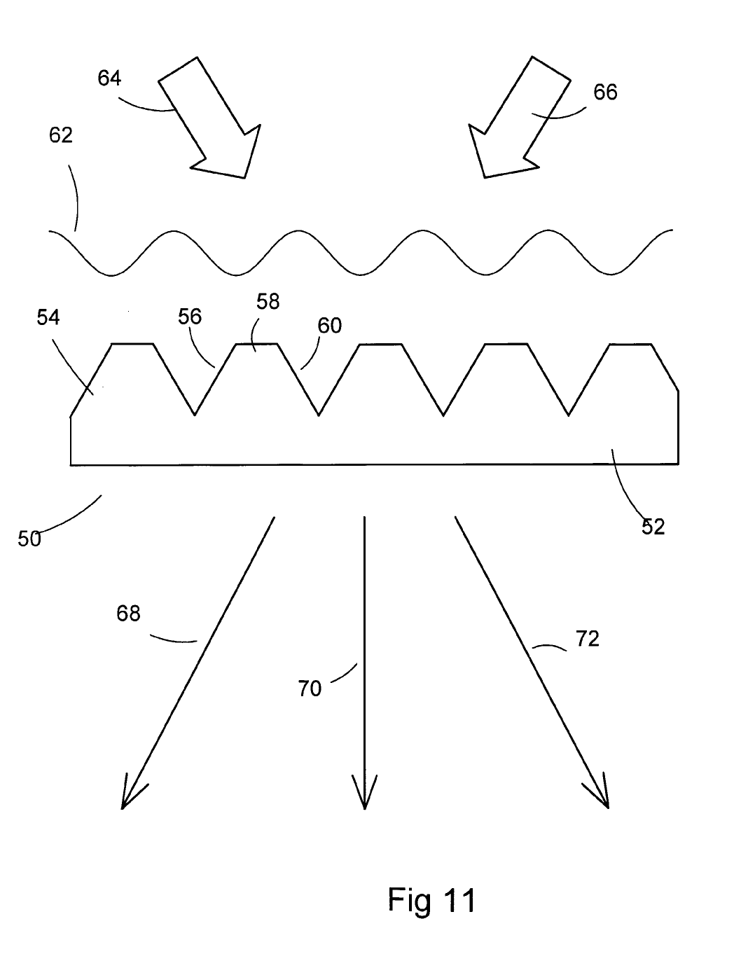

FIG. 11 illustrates an optical device having a profiled upper surface;

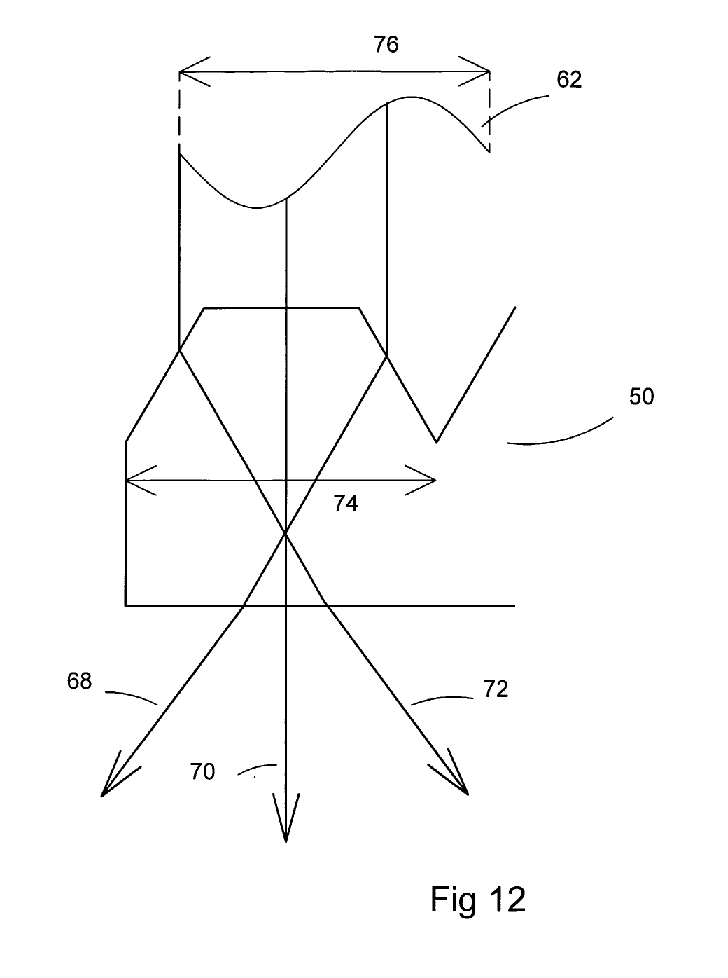

FIG. 12 illustrates the optical device of FIG. 11 showing the deflected light paths;

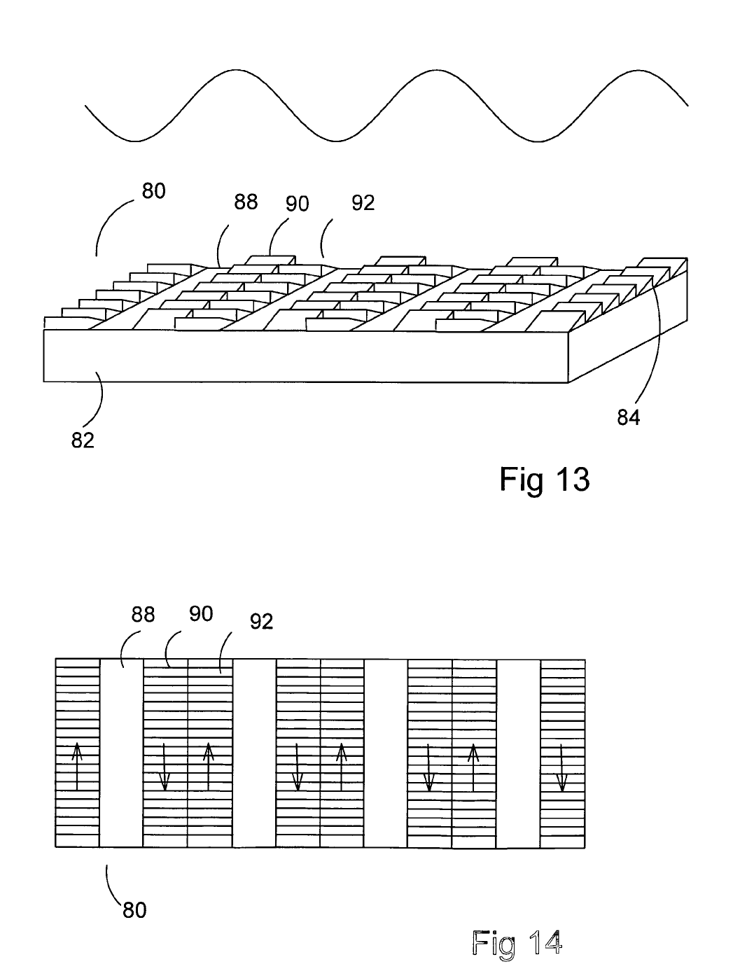

FIG. 13 illustrates a perspective view of an optical device including blazed gratings;

FIG. 14 is a plan view of the optical device of FIG. 13;

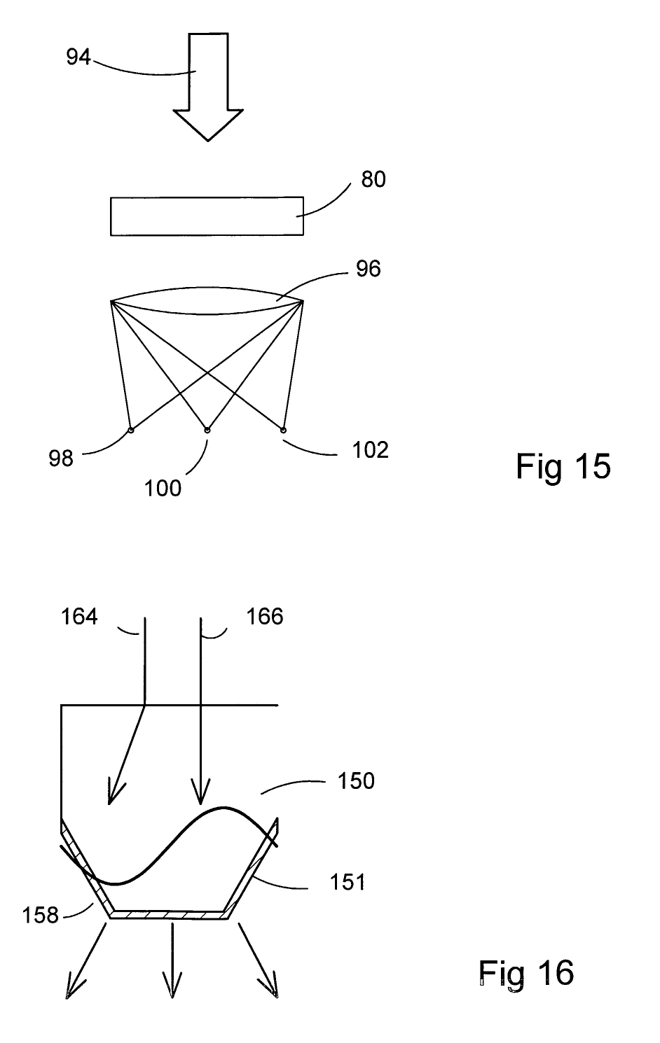

FIG. 15 is a side view of the optical device of FIG. 13;

FIG. 16 is a schematic illustration of a birefringent optical device having a profiled upper surface; and

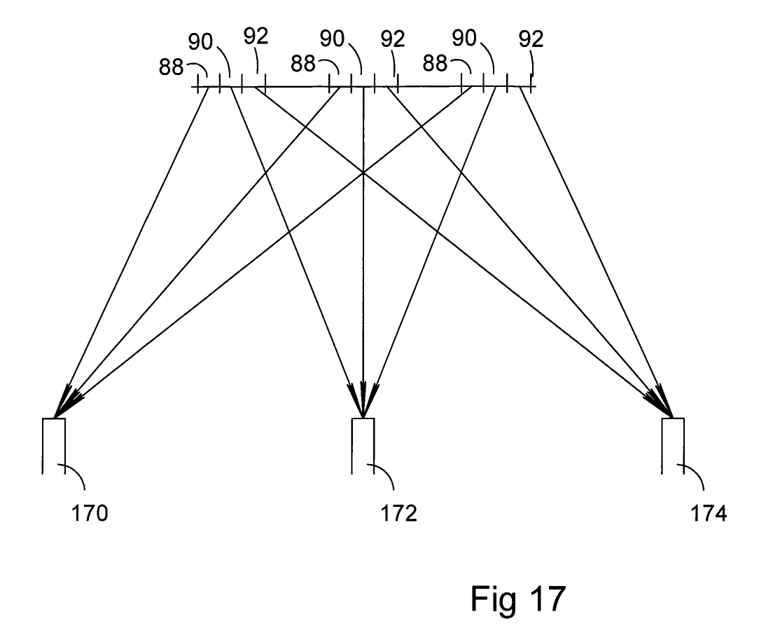

FIG. 17 illustrates light passing through the optical device of FIGS. 13-15 being focused into optical fibres by a Fresnel zone plate.

FIG. 1 illustrates a prior art interferometer, which is described in GB2296766. A light source 1 produces a coherent light beam 2 directed towards a polarising cubic beam splitting device 3. The polarising beam splitter 3 produces from the light beam 2 a first, transmitted beam 2a and a second reflected beam 2c. Use of the polarising beam splitter 3 ensures that the transmitted and reflected beams 2a, 2c are orthogonally polarised with respect to each other. The first transmitted beam 2a, which in this example forms the measuring arm of the interferometer, passes straight through the polarising beam splitter 3 and is directed towards a retroreflector 6 attached to a moving object (not show) the position of which is to be measured by the interferometer. The retroreflector returns the light beam as beam 2b to the polarising beam splitter 3. The return beam 2b is transmitted through the polarising beam splitter and passes onwards towards a detection unit 4.

The polarising beam splitter 3 also produces a second, reflected beam 2c, which forms the reference arm of the interferometer. The reflected beam is directed towards a second retroreflector 7 which is fixed with respect to the beam splitter 3 and then reflected by the retroreflector back to the polarising beam splitter. On its return the beam 2d is reflected from the polarising beam splitter towards the detection unit.

As previously mentioned, this arrangement causes beams 2b and 2d to have different polarisation states.

A birefringent prism 8 refracts the beams 2b, 2d through different angles causing them to converge and the polarising element 9 mixes their polarisation states so that they interfere and generate a spatial fringe field.

The detection unit 4 is placed in the path of the overlapping beams to receive the spatial fringe field. The detector used is an electrograting. Such a detector is known from our European Patent No. 0543513 and consists of a semiconductor substrate upon which a plurality of elongate, substantially parallel photosensitive elements are provided.

The present invention provides a detection unit in which signals are created from the spatial fringe field without the requirement of an electrograting. FIG. 2 illustrates a detection unit 10 comprising a diffractive optical element (DOE) 12, a lens 14 and four detectors 16,18,20,22. A spatial fringe field 24 comprising cosine fringes is formed at the detection unit 10 by the interference of two coherent light beams 26,28 (i.e. the measurement arm and reference arm of an interferometer as shown in FIG. 1).

When the detection unit 10 is illuminated by the cosine fringes four beams 30,32,34,36 are formed which are focused by lens 14 onto detectors 16,18,20,22. The lens could be integral with the DOE. Alternatively four individual lenses could be used. The four beams are 90° out of phase and thus the intensities detected at the detectors vary in quadrature as the cosine fringes are translated across the detection unit.

FIG. 3 illustrates the intensity variation at the detectors 16,18,20,22 over time as the cosine fringes are moved laterally relative to the detection unit 10.

It can be seen that the intensities at each detector 16,18,20,22 vary cyclically and are 90° out of phase with one another.

The invention is not restricted to producing four light beams. For example the DOE may be designed to create three beams which are π/2 or 4π/3 out of phase depending upon the design. The output of the detectors may be combined to generate quadrature signals which may be used to interpolate the magnitude and direction of relative movement between the fringes and the periodic light pattern. The method of combining outputs from three detectors to generate such quadrature signals is disclosed in our earlier published International Patent Application WO87/07944.

The mathematical specification of the DOE may be calculated as follows with reference to FIGS. 4-8.

FIG. 4 shows cosine fringes 24 incident on a DOE 40 to provide four beams a,b,c,d which vary in intensity I₁,I₂,I₃,I₄ and quadrature as the cosine fringes are translated relative to the readhead. The cosine fringes may be described by the equation:

$$Ufringes ( x ) = cos \frac{2 π ( x - Δ x )}{p}$$

where x is the linear displacement; Δx is the change in linear displacement; and p is the periodicity of the complex amplitude field produced by the interference of the two incident beams. The periodicity of the intensity interference pattern is p/2.

The output complex amplitude Ωout(ω) of the DOE is given by the Fourier transform of the product of the cosine fringes (Ufringes (x)) and the DOE as shown below. Output coordinates are
x=ω·λz
where λ is the wavelength of the incident light, ω is the spatial angular frequency of the co-ordinate system, and z is the propagation distance.

$$\begin{matrix}Ω out ( ω ) = Ft [ Ufringes ( x ) \cdot Ugrating ( x ) ] \\ = Convolution [ Ft [ Ufringes ( x ) , Ft [ Ugrating ( x ) ] \\ = Convolution [ Ω fringes ( ω ) , Ω grating ( ω ) ]\end{matrix}$$

where Ft is the Fourier Transform.

The form of the complex amplitude of the grating Ωgrating(ω) must be such that when convolved with the complex amplitude of the fringes Ωfringes(ω) it produces at least four beams. Furthermore as the intensity of the four beams is required to vary in quadrature with Δx, it is necessary for the complex amplitude of each beam to consist of at least two components so that the required phase relationship can be imposed. (Single component beams are not suitable as they would have constant intensity.) A possible solution is illustrated in FIG. 5. FIG. 5 illustrates the convolution of Ωgrating(ω) and Ωfringes(ω) to produce Ωout(ω). A−E are complex numbers and
φ=2πΔx/p

The output intensity is given by the square of the modulus of the output amplitude. The intensities of the four beams can then be equated to the required quadrature signals:
Iₙ(Δx)=1+q Cos (2φ+nπ/2)
where q is the AC modulation with a DC level of unity.

Let I₁ be the modulus squared of the complex amplitude of the first output beam resulting from the combination of the incident beams and the property of the DOE, then

$$\begin{matrix}{I}_{1} = {\vert 1 / 2 ( A {ⅇ}^{- ⅈ ϕ} + B {ⅇ}^{+ ⅈ ϕ} ) \vert}^{2} \\ = 1 / 4 ( A {ⅇ}^{- ⅈ ϕ} + B {ⅇ}^{ⅈ ϕ} ) ( A * {ⅇ}^{ⅈ ϕ} + B {ⅇ}^{- ⅈ ϕ} )\end{matrix}$$

This can be related to the required modulated intensity terms by

$$\begin{matrix}{I}_{1} = 1 / 4 ( {\vert A \vert}^{2} + {\vert B \vert}^{2} + A B * {ⅇ}^{- 2 ⅈ ϕ} + A * B {ⅇ}^{2 ⅈ ϕ} ) \\ = 1 + q Cos 2 ϕ \\ = 1 + \frac{q}{2} ( {ⅇ}^{2 ⅈ ϕ} + {ⅇ}^{- 2 ⅈ ϕ} )\end{matrix}$$

Similarly

$$\begin{matrix}{I}_{2} = 1 / 4 ( {\vert B \vert}^{2} + {\vert C \vert}^{2} + B C * {ⅇ}^{- 2 ⅈ ϕ} + B * C {ⅇ}^{2 ⅈ ϕ} ) \\ = 1 + q Cos ( 2 ϕ + π / 2 ) \\ = 1 + \frac{q}{2} ( {ⅇ}^{ⅈ ( 2 ϕ - π / 2 )} + {ⅇ}^{- ⅈ ( 2 ϕ - π / 2 )} ) \\ {I}_{3} = 1 / 4 ( {\vert C \vert}^{2} + {\vert D \vert}^{2} + C D * {ⅇ}^{- 2 ⅈ ϕ} + C * D {ⅇ}^{2 ⅈ ϕ} ) \\ = 1 + q Cos ( 2 ϕ - π ) \\ = 1 + \frac{q}{2} ( {ⅇ}^{ⅈ ( 2 φ - π )} + {ⅇ}^{- ⅈ ( 2 φ - π )} ) \\ {I}_{4} = 1 / 4 ( {\vert D \vert}^{2} + {\vert E \vert}^{2} + D E * {ⅇ}^{- 2 ⅈ ϕ} + D * E {ⅇ}^{2 ⅈ ϕ} ) \\ = 1 + q Cos ( 2 ϕ - 3 π / 2 ) \\ = 1 + \frac{q}{2} ( {ⅇ}^{ⅈ ( 2 ϕ - 3 π / 2 )} + {ⅇ}^{- ⅈ ( 2 ϕ - 3 π / 2 )} )\end{matrix}$$

Thus

$$1 / 4 A {B}^{*} = \frac{q}{2} and 1 / 4 A * B = \frac{q}{2}$$

$$1 / 4 B {C}^{*} = \frac{q}{2} {ⅇ}^{+ ⅈ π / 2} and 1 / 4 B * C = \frac{q}{2} {ⅇ}^{- ⅈ π / 2}$$

$$1 / 4 C {D}^{*} = \frac{q}{2} {ⅇ}^{+ ⅈ π} and 1 / 4 C * D = \frac{q}{2} {ⅇ}^{- ⅈ π}$$

$$1 / 4 D {E}^{*} = \frac{q}{2} {ⅇ}^{+ ⅈ 3 π / 2} and 1 / 4 D * E = \frac{q}{2} {ⅇ}^{- ⅈ 3 π / 2}$$

The equations on the right hand side are just complex conjugates of the left hand side ones and can be neglected.

Starting with an arbitrary A value.

$$B = {( \frac{2 q}{A} )}^{*}$$

$$C = {( ( 2 q / B ) {ⅇ}^{ⅈ π / 2} )}^{*}$$

$$D = {( ( 2 q / C ) {ⅇ}^{ⅈ π} )}^{*}$$

$$E = {( ( 2 q / D ) {ⅇ}^{ⅈ 3 π / 2} )}^{*}$$

Now let A=1,q=½, then the values of A−E are
A=1
B=1
C=−i
D=+i
E=−1

This system is illustrated in FIG. 6. FIG. 6a shows the real and imaginary parts of the grating amplitude against displacement x, FIG. 6b shows the phase and intensity of the grating against displacement x and FIG. 6c shows the output intensity in the spatial frequency co-ordinate system (ω).

Two alternative solutions are also possible, which differ only in the order of the phases. These are illustrated in FIGS. 7 and 8.

FIG. 7a shows the real and imaginary parts of the grating amplitude against displacement x, FIG. 7b shows phase and intensity of the grating against displacement x and FIG. 7c shows the intensity in the spatial frequency co-ordinate system (ω) for the four resulting beams a,b,c,d for the values of A−E below:
A=1
B=e^{i0π/2}/A
C=e^{i1π/2}/B
D=e^{i3π/2}/C
E=e^{i2π/2}/D

Thus

| | | | | |
|---|---|---|---|---|
| A = 1 | B = 1 | C = i | D = −1 | E = 1 |

FIG. 8a shows the real and imaginary parts of the grating amplitude against displacement x, FIG. 8b shows phase and intensity of the grating against displacement x and FIG. 8c shows the intensity in the spatial frequency co-ordinate system (ω) for the four resulting beams a,b,c,d for the values of A−E below:
A=1
B=e^{i0π/2}/A
C=e^{i2π/2}/B
D=e^{i1π/2}/C
E=e^{i3π/2}/D

Thus

| | | | | |
|---|---|---|---|---|
| A = 1 | B = 1 | C = −1 | D = −i | E = 1 |

It is also possible to use the D.O.E. to produce three resultant beams. A possible solution is illustrated in FIG. 9 and the equations below.
A=1
B=e^{-i.1.π/2}/A
C=e^{i.0.π/2}/B
D=e^{i.1.π/2}/C

| | | | |
|---|---|---|---|
| A = 1 | B = −i | C = i | D = 1 |

FIG. 10a illustrates the real and imaginary parts of the grating amplitude for a three phase splitter grating,

FIG. 10b illustrates the phase and intensity of the three phase splitter grating and FIG. 10c illustrates the output intensity against angular displacement (A) for the three output beams a,b,c.

The above solutions are specific analytical solutions. Numerical optimisation of the DOE will typically use a computer and produce designs that may not be of the above form but may make the DOE easier to make and use.

An alternative optical device for forming a plurality of light beams from spatial fringe field will now be described with reference to FIGS. 11 and 12.

FIG. 11 illustrates an optical device 50 comprising a transparent, eg glass, element 52 with a profile 54 on one surface comprising a repeating pattern of three surfaces 56, 58, 60 of equal distance angled at for example 120° from one another.

This profile may be formed from a saw tooth profile, in which the top third is removed (for example, by polishing).

A spatial fringe field comprising cosine fringes 62 is formed at the optical device 50 by the interference of two coherent light beams 64,66. FIG. 11 shows cosine fringes 62 incident on the optical device 50. Light incident on the profiled optical device is refracted in three different directions 68, 70, 72 by the three angled surfaces, as shown in FIG. 12. The period of the optical device 74 is equal to the period of the cosine fringes 76, resulting in the three resultant light beams having different phases of 0°, +120° and −120°.

Detectors (not shown) are provided to detect the three resultant light beams 68,70,72. Alternatively, optical fibres may be provided to couple the three resultant light beams to their respective remote detectors.

In a reverse arrangement, the coherent light beams 64,66 are incident on the plane face of the optical device, so that the light travels across the profiled glass/air boundary from the glass side. In this arrangement the angle of incidence of the light beams 64,66 will be greater than the arrangement illustrated in FIGS. 11 and 12 to produce a fringe pitch in the glass which is equal to the period of the profiled surface.

The incident beams which interfere with each other to produce an interference pattern do not have to be at an angle to one another. FIG. 16 illustrates an embodiment in which the optical device 150 is made from a birefringent material which has a polaroid material 151 coated onto its profiled surface 158. Two parallel beams 164,166 which are orthogonally polarised are incident on the optical device, and are refracted by differing degrees by the birefringent material. The beams are thus no longer parallel when they meet and interfere at the polarising coating to form an interference pattern. The interference pattern interacts with the profiled surface as previously described with reference to FIGS. 11 and 12.

Another type of profiled optical element will now be described with reference to FIGS. 13-15. In this embodiment, the optical device 80 comprises a transparent element 82, e.g. glass, with a profiled surface 84.

The profiled surface 84 of the optical device is divided into a repeating pattern of segments 88,90,92, the pattern of segments extending parallel with the direction of the light fringes 86. FIGS. 13 and 14 show the repeating pattern of segments. FIG. 13 is a perspective view of the optical device and FIG. 14 is a plan view. Each repeatable section of the pattern comprises a first segments 88 in which there is no structure, a second segment 90 in which there is a blazed grating extending in a first direction (shown by arrow A in FIG. 14) and a third segment 92 in which there is a blazed grating extending in a second direction (shown by arrow B in FIG. 14).

Light incident on the different segments of the profiled surface of the optical device is diffracted into different directions. Light incident on the first segment without any structure passes straight through the optical device (i.e. 0th order of diffraction). Light incident on the second and third segments is refracted at different angles.

FIG. 15 is an end view of the optical element of FIGS. 13 and 14. Light 94 incident on the top face of the optical device 80 passes straight through segment 88 (without structure), is diffracted in a first direction passing through the segment 90 (with a blazed grating in a first direction) and is diffracted in a second direction passing through the segment 92 (with a blazed grating in a second direction). The light beams produced by the three segments are focussed by lens 96 into three light spots 98,100,102 which are transverse to the direction of the repeating pattern of segments. As light incident on each of the segments 88,90,92 each relates to a different part of the cosine fringes, the three light spots will each have different phases, i.e. 0°, +/−120°.

Use of a blazed grating has the advantage that the lens 96 may be incorporated into the optical device 80 by superimposing a Fresnel zone plate onto the blazed grating, thus reducing the total size of the system.

FIG. 17 illustrates part of the Fresnel zone plate which focuses light into the optical fibres. The zone plate comprises sets of sections A,B,C with each section of a given set focusing the light to a given focal point. Difference sets of sections focus light to different focal points. The Fresnel zone plate may be configured so that the focal points are arranged either parallel or transverse to the plane of the optical fibre. FIG. 17 shows light diffracted by a first set of segments 88 of the blazed grating being focused into a first optical fibre 170, light diffracted by a second set of segments 90 of the blazed grating being focused into a second optical fibre 172 and light diffracted by a third set of segments 192 of the blazed grating being focused into a third optical fibre 174.

A coherent optical fibre bundle may replace both the optical device and the discrete optical fibres. In this case one end of the individual optical fibres in the bundle are positioned adjacent the spatial fringe field and spaced so that light of different phases travels through different optical fibres to different detectors.

If heat from the electronics is acceptable then photodetectors could be used instead of the optical fibres. Here the photodetectors could be separate, or housed within the same unit or they may even have a common substrate as in quadcells or linear arrays.

Although FIGS. 11-17 illustrate transmissive systems, a reflective optical device may also be used in the invention.

All of the above embodiments provide alternatives for an opto-electronic grating, thus providing a detection unit in which no electronics are required. Furthermore, as the detectors may be provided remotely from the detection unit (i.e. by use of optical fibres), the size of the readhead may be greatly reduced.

The detection units described above are suitable for use with any interferometer in which a spatial fringe field is produced.

1. Interferometry apparatus comprising:
a measurement light beam and a reference light beam which interact with each other to cause a spatial fringe pattern;
an optical device which interacts with the spatial fringe pattern, such that light is spatially separated into different directions;
and wherein the intensity modulation in two or more directions of the spatially separated light is phase shifted.

2. Interferometry apparatus according to claim 1 wherein the optical device interacts with the spatial fringe pattern such that within a fringe of the spatial fringe pattern, light is spatially separated into different directions.

3. Interferometry apparatus according to claim 1 wherein the light is spatially separated over at least a portion of one or more fringes of the spatial fringe pattern.

4. Interferometry apparatus according to claim 1, wherein the light is spatially separated into two or more sub-beams.

5. Interferometry apparatus according to claim 1 wherein the spatially separated light in different directions is detected by optical detectors.

6. Interferometry apparatus according to claim 5 wherein the spatially separated light reaches the detectors via optical fibres.

7. Interferometry apparatus according to claim 5 wherein at least one focussing means is provided to focus the spatially separated light in the different directions into the optical fibres or onto the optical detectors.

8. Interferometry apparatus according claim 1 wherein the optical device comprises at least one fresnel lens.

9. Interferometry apparatus according to claim 1 wherein the optical device is a diffractive device.

10. Interferometry apparatus according to claim 9 wherein the optical device comprises a plurality of segments, wherein light from the spatial fringe field incident on each segment is diffracted into a different diffraction direction, thereby spatially separating the spatial fringe field.

11. Interferometry apparatus according to claim 9 wherein the optical device has a plurality of segments having different structures, the different segments being arranged in a repeating pattern.

12. Interferometry apparatus according to claim 10 wherein two or more segments of the plurality of the segments comprise blaze gratings, wherein the blaze gratings extend in different directions.

13. Interferometry apparatus according to claim 10 wherein one of the plurality of segments has no structure.

14. Interferometry apparatus according to claim 1 wherein the optical device is a diffractive optical element.

15. Interferometry apparatus according to claim 1 wherein the optical device is a refractive device.

16. Interferometry apparatus according to claim 15 wherein the optical device comprises a plurality of segments, wherein light from the spatial fringe field incident on each segment is refracted into a different direction, thereby spatially separating the spatial fringe field.

17. Interferometry apparatus according to claim 15 wherein the optical device has a profiled surface, such that refraction at the profiled surface causes spatial separation of the spatial fringe field.

18. Interferometry apparatus according to claim 1, wherein the optical device comprises a coherent optical fibre bundle.

19. Interferometry apparatus according to claim 1 wherein the optical device is configured such that the phase difference of the spatially separated light beam enables outputs of the detectors to be combined to generate two signals with a known phase difference.

20. Interferometry apparatus according to claim 19 wherein the optical device is configured such that the phase difference of the spatially separated light beam enables outputs of the detectors to be combined to generate quadrature signals.
